(19) United States
(12) Patent Application Publication
(10) Pub. No.: US 2026/0348438 A1
(43) Pub. Date: Nov. 5, 2026

(54) Mechanical Rotary Coupling with One-Sided Locking Capability

(71) Applicant: Robert Bosch GmbH, Stuttgart (DE)

(72) Inventors: Eddy Dupont, Cloyes les trois rivieres (FR); Laurent Fevre, Saint Sulpice de (FR)

(21) Appl. No.: 19/120,770

(22) PCT Filed: Oct. 19, 2023
(86) PCT No.: PCT/EP2023/079171

§ 371 Date: Apr. 12, 2025

(30) Foreign Application Priority Data
Oct. 21, 2022 (FR) 2210966

(51) Int. Cl. F16D 41/10; B62D 1/181; F16D 41/066

(52) U.S. Cl. CPC F16D 41/105; B62D 1/181; F16D 2041/0665

(57) ABSTRACT

A mechanical coupling device for selective rotational coupling of a first shaft to a second shaft includes (i) a first rotating body which is designed to be rotationally fixedly connected to the first shaft, (ii) a second rotating body which is designed to be rotationally fixedly connected to the second shaft, (iii) a rotationally fixed ring surrounding the first body and the second body along an overlap section at which the first and second bodies overlap, and (iv) a blocking unit for rotation of the first shaft by the second shaft including a groove bounded by the ring, as well as an elastic element and a rolling element encapsulated in the groove. The rolling element is held in a position clamped in the groove by being pushed by the elastic member towards an opening of the groove, the cross-section of which is smaller than the corresponding dimension of the rolling element. The first body includes a release section for allowing rotation of the second shaft by the first shaft. The release section extends opposite the groove opening to be suitable for coming into contact with the rolling element to disengage it from its clamped position.

### TECHNICAL FIELD

The present invention relates to the general field of mechanical force transfer and, more particularly, to a coupling device between a first and a second concentric rotating element, for example, shaft ends, which permit a second element to be rotated by the first element and at the same time block a rotation of the first element by the second element.

The device is expediently usable to equip an electromechanical actuator for moving an arm of a steering column assembly with reversible screw-nut type motion transducer, however, the invention is not limited to this specific application.

### TECHNICAL BACKGROUND

The steering column is one of the components that form the steering system of a vehicle. It is present in all vehicles and facilitates the connection between the steering wheel and the wheels.

As is known, the steering column comprises a fixed beam rigidly mounted to a superstructure element of the vehicle, such as the chassis, and a steering shaft supporting the steering wheel while extending the fixed beam into the interior of the vehicle towards the seat on which the driver is seated.

In practice, the space between the steering wheel and the seat must be large enough for the driver to sit comfortably in the seat without having to twist. This particularity is often at odds with the driving position, in which the space measured between the steering wheel and the seat is rather limited, in order to allow the driver a comfortable and secure grip of the steering wheel.

To solve this problem, it has been proposed to provide the steering shaft with the ability to retract and extend as needed.

In this solution, the steering wheel is movable between a retracted position in which the steering wheel is far enough from the seat to not interfere with the driver sitting down, and an extended position in which the seat-steering wheel space is reduced to allow for a comfortable grip of the steering wheel. It should be noted that this solution is particularly interesting for equipping an autonomous vehicle in which a retracted steering wheel position can be set for convenience in a driving situation that does not require manual travel control.

An electromechanical drive has been proposed to control the feed of the steering shaft, allowing movement of the steering wheel without driver intervention. Classically, the electromechanical drive employs an electric motor and a screw-nut system, wherein the screw is rotated to move the nut, and wherein the position of the nut causes the feed of the steering shaft.

Typically, the screw-nut system is designed to be irreversible by allowing movement of the nut along the screw solely in response to rotation thereof by the electric motor and thereby preventing spontaneous movement of the nut. This particularity prevents the steering wheel from being unexpectedly adjusted by a force exerted by the driver on the steering wheel, which is not permitted to ensure vehicle control.

However, the irreversible nature of the screw-nut system requires limiting the speed at which the nut moves along the length of the screw, which corresponds to a capping of the speed at which the steering wheel can be adjusted.

In order to meet the comfort requirements of users, the invention aims to propose a solution that allows the safe use of a reversible screw-nut system, which can reduce the wait time associated with setting the steering wheel.

### DISCLOSURE OF THE INVENTION

To this end, the invention concerns a mechanical coupling device for selective rotational coupling of a first shaft to a second shaft to enable rotation of the second shaft by the first shaft while at the same time blocking rotation of the first shaft by the second shaft, wherein the coupling device comprises the following:
a first rotating body, which is designed to be rotationally fixedly connected to the first shaft or form a constitutive element thereof;
a second rotating body, which is designed to be rotationally fixedly connected to the second shaft or form a constitutive element thereof, wherein the second body extends concentrically with the first body along a longitudinal axis;
a rotationally fixed ring that surrounds the first body and the second body radially to the longitudinal axis along an overlap section at which the first and second bodies overlap longitudinally;
a first blocking unit for rotation of the first shaft by the second shaft in a first direction of rotation, wherein the first blocking unit comprising a first groove as well as a first elastic element and a first rolling element encapsulated in the first groove, wherein:
the first groove extends in a circumferential direction defined as a yaw direction about the longitudinal axis, wherein it is bounded between a groove base wall formed by the second body and a groove opening, wherein the first direction of rotation is defined as the direction from the groove opening to the groove base;
the first groove is radially bounded by a web formed by the second body and by a cylindrical inner ring of the wall opposite the web surface, wherein the web is shaped such that the radial extension of the groove decreases with increasing proximity to the groove opening in the circumferential direction such that the rolling element cannot be disengaged from the groove by the groove opening;
the first elastic element is disposed between the groove base wall and the first rolling element, wherein the first elastic element passively pushes the first rolling element away from the groove base wall under elastic pre-tensioning to press it towards the groove opening until the first rolling element is held between the web and the inner ring wall in a clamped position;
wherein the first body comprises a release section, to permit rotation of the second shaft by the first shaft in the first direction of rotation, wherein the release section extends in the circumferential direction opposite the groove opening, to be able to come into contact with the first rolling element and to press it towards the groove base, when the first body is turned in the first direction of rotation, which is opposite the direction of pre-tension of the first elastic element, while at the same time the torque is sufficient to overcome the pre-tension of the first elastic element and disengage the first rolling element from the clamped position.

The invention also relates to a correspondingly defined mechanical coupling device, which comprises a second blocking unit for rotation of the first shaft by the second shaft in a second direction of rotation, which is opposite to the first direction of rotation, wherein the second blocking unit comprises a second groove defined between the ring and the first and the second bodies, as well as a second elastic element and a second rolling element, which are encapsulated in the second groove, wherein:
the second groove extends in the circumferential direction, bounded by a respective groove base wall formed by the second body and a respective groove opening, wherein the second groove is aligned such that the direction from the opening of the second groove to the base wall of the second groove corresponds to the second direction of rotation,
the second groove is radially bounded by a web formed by the second body and by the cylindrical inner wall of the ring opposite this web, wherein the web is shaped such that the radial extension of the second groove decreases with increasing proximity to the opening of the second groove in the circumferential direction, so that the second rolling element cannot be disengaged from the second groove through the second groove opening;
the second elastic element is disposed between the base wall of the second groove and the second rolling element, wherein the second elastic element passively pushes the second rolling element away from the base wall of the second groove to press it towards the opening of the second groove until the second rolling element is held between the web and the inner ring wall in a clamped position;
and wherein the first body comprises a second release section, to permit rotation of the second shaft by the first shaft in the second direction of rotation, wherein the second release section extends in the circumferential direction opposite the opening of the second groove, to be able to come into contact with the second rolling element and to press it towards the base wall of the second groove, when the first body is turned in the second direction of rotation, which is opposite the direction of pre-tension of the second elastic element, while at the same time the torque is sufficient to overcome the pre-tension of the second elastic element and disengage the second rolling element from the clamped position.

The invention also relates to a correspondingly defined mechanical coupling device, in which the rotation of the second shaft by the first shaft in the direction of rotation, which is blocked by the corresponding blocking unit, is ensured by a first support surface of the first body, which comes into contact with a support surface of the second body, when the rolling element is released from the clamped position by the release section, wherein the first and second support surfaces may overlay each other in the circumferential direction.

The invention also relates to a correspondingly defined mechanical coupling device, wherein rotation of the second shaft by the first shaft in the direction of rotation blocked by the corresponding blocking unit is ensured by the rolling element and the corresponding elastic element forming a contact interface between the release section of the first body and the groove base wall of the blocking unit.

The invention also relates to a steering column assembly for a steering system of a vehicle, for example a motor vehicle, comprising:
a steering column body provided to be fixedly mounted to a vehicle structure;
an arm supported by the steering column body and extending in a longitudinal direction, wherein the arm is at least partially fitted into the steering column body and is translationally displaceable in the longitudinal direction with respect to the steering column body;
an electromechanical actuator for translational displacement of the arm in the longitudinal direction, wherein the electronic actuator comprises:
an electric motor for rotary drive;
a screw-nut type motion transducer which converts a rotation provided by the electric motor into a displacement of the arm, wherein the motion transducer comprises a threaded rod that is translation-resistant with respect to the steering column body and a nut that is rotation-resistant and translationally fixedly connected to the arm in the longitudinal direction;
a correspondingly defined mechanical rotational coupling device for rotationally coupling the threaded rod to a drive shaft driven rotationally at the output of the electric motor.

The invention also relates to a correspondingly defined steering column assembly, wherein the mechanical rotational coupling device is an integral component of a drive mechanism which is contained in a housing mounted to the steering column body, and via which a rotation provided by the electric motor is transferred to the threaded rod, wherein the drive mechanism comprises the drive shaft, driven by the electric motor, wherein the first body comprises a pinion which extends beyond the overlap section, wherein the pinion comprises a toothing which engages with the toothing of the drive shaft.

The invention also relates to a correspondingly defined steering column assembly, wherein the ring is formed by the housing.

The invention also relates to a correspondingly defined steering column assembly, wherein the ring is attached to the housing.

The invention also relates to a correspondingly defined steering column assembly, wherein the rolling element(s) is/are rollers.

The invention also relates to a correspondingly defined steering column assembly, wherein the elastic member(s) is/are formed from a metallic strip.

### BRIEF DESCRIPTION OF THE DRAWINGS

Further features and advantages of the invention will be apparent upon reading the detailed description below; please refer to the accompanying drawings for assistance in understanding the description. The figures show:

FIG. 1 a perspective view of a steering column assembly according to one embodiment of the invention comprising a frame, an arm displaceable with respect to the frame, and an electromechanical actuator for movement of the arm;

FIG. 2 a detail view of a gear motor unit of the electromechanical actuator of FIG. 1;

FIG. 3A a first exploded view of a portion of the gear motor of FIG. 2, in particular showing a mechanical coupling device 38;

FIG. 3B an exploded second view of a portion of the gear motor of FIG. 2 from a different perspective than that of FIG. 3A;

FIG. 4 a sectional view of an overlap section of the mechanical coupling device according to the invention along the torque plane A-A of FIG. 1;

FIG. 5 an enlarged detail view of FIG. 4;

FIG. 6A a sectional view of the mechanical coupling device corresponding to that of FIG. 4 and illustrating rotational blocking dynamics;

FIG. 6B a sectional view of the mechanical coupling device corresponding to that of FIG. 4 and illustrating rotational coupling dynamics.

### DETAILED DESCRIPTION OF THE INVENTION

In the following description, identical, similar or analogous elements are marked with the same reference characters.

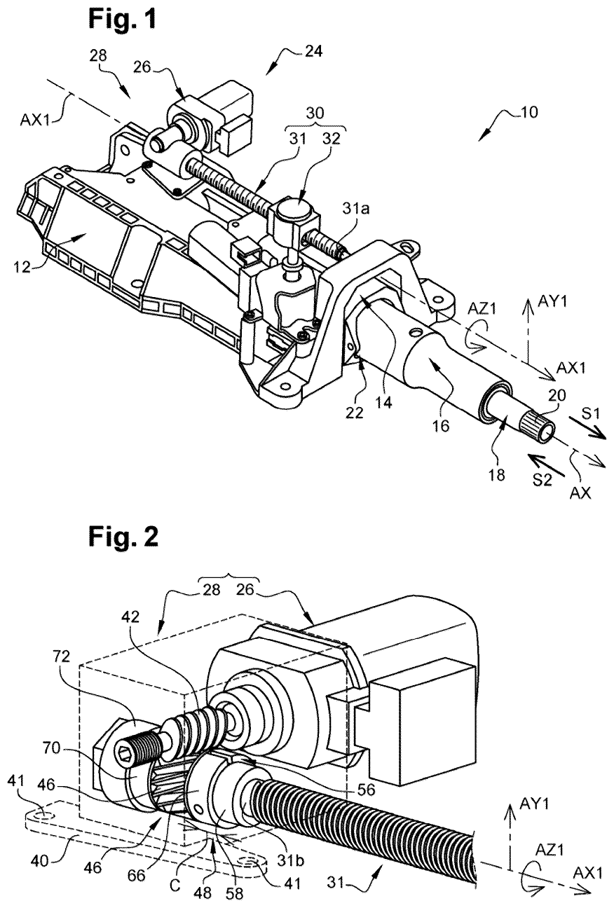

Referring to FIG. 1, a steering column assembly 10 for a steering system of a vehicle is shown. This assembly 10 includes a frame 12 that is designed to be rigidly attached to a superstructure element of a vehicle, such as a steering shaft, a steering column body 14 supported by the frame 12, and an arm 16 supported by the steering column body 14. The arm 16 encloses a steering shaft 18 that is provided to support a steering wheel of the vehicle, which is not shown.

The steering shaft 18 extends along an AX axis aligned in the longitudinal direction. The steering shaft 18 extends along the arm 16, which also has a longitudinal extension and is provided for being rotationally connected to the steering wheel in a rigid coupling. In particular, this steering shaft 18 has a free end 20 that extends beyond the arm 16 in the longitudinal direction to receive the steering wheel of the vehicle by press fitting.

In the example of FIG. 1, the free end 20 has a generally circular contour in the longitudinal section and defines a groove that is provided to receive a projection that forms a pin that is configured on a corresponding recess of the steering wheel. It should be noted, however, that any other type of shape may be provided to correspond to the negative of the recess formed on the steering wheel in which the free end 20 engages. For example, the free end 20 may have outer grooves that engage with inner grooves formed on the corresponding recess of the steering wheel to ensure a rotational coupling.

In the context of the invention, the steering column assembly 10 is provided to allow for setting of the longitudinal position of the steering wheel in the passenger compartment of the vehicle equipped therewith.

To this end, the arm 16 is attached to the steering column body 14 and can be moved longitudinally. In detail, the arm 16 and steering column body 14 are designed to permit relative movement in the longitudinal direction, which is consistent with the practice of movement of the arm 16 with respect to the steering column body 14, since the steering column body 14 is fixedly connected in the longitudinal direction to the frame 2, which is fixed after installation in the vehicle. It should be noted that the steering column body 14 may be swivel-mounted with respect to the frame 12 to additionally allow for height adjustment of the steering wheel in the passenger compartment, while always maintaining a longitudinal connection with the frame 12.

In the example of FIG. 1, the steering column body 14 comprises a bore 22 in which arm 16 is mounted in a displaceable manner to allow longitudinal movement of the arm 16.

In addition, the steering shaft 18 is translationally connected to the arm 16 so that it is carried by the arm 16 during its longitudinal movement. It should be understood that, due to the fact that the steering shaft 18 supports the steering wheel and is also translationally fixedly connected to the movement of the arm 16, the relative positioning of the arm 16 with respect to the steering column body 14 determines the position of the steering wheel in the passenger compartment of the vehicle.

In practice, arm 16 acts like a muscle: Its actuation causes a change in the longitudinal extension of the steering shaft 18 and accordingly results in a movement of the steering wheel which is fixedly connected to the steering shaft 18.

Advantageously, the steering shaft 18 is of a telescopic nature along its extension in the arm 16 to maintain its ability to transfer a steering wheel rotation while maintaining a translational degree of freedom.

The movement of the arm 16 relative to the steering column body 14 is ensured by an electromechanical actuator 24. The electromechanical actuator 24 includes an electric motor 26 that translationally drives the arm 16 via a drive mechanism 28.

The drive mechanism 28, in particular, includes a screw-nut-type motion transducer 30 that converts a rotation provided by the electric motor 26 into a displacement of the arm 16. The motion transducer 30 comprises a threaded rod 31 and a nut 32 supported by the threaded rod. The nut 32 and threaded rod 31 comprise an outer thread and an inner thread, respectively, that engage with one another.

According to the embodiment illustrated in FIG. 1, the threaded rod 31 is translationally fixed with respect to steering column body 14 and rotatable along its rod axis AX1. The rod axis AX1 is substantially parallel to the longitudinal orientation axis AX, which coincides with the axis of rotation of the arm 16, which in this example is in the form of a tube. In practice, there may be a small angular deviation between the AX1-Achse and the AX axis, without this affecting proper operation of the electromechanical actuator 24.

The threaded rod 31 is mounted on the steering column body 14 and comprises a first free end 31a and a second end 31b to which the rod is secured against displacement.

In addition, the nut 32 is translationally fixedly connected to the arm 16 by being fixedly attached thereto and secured against rotation about the threaded rod 31. The nut 32 extends in a radial direction AY1 about the threaded rod 31, wherein the radial direction AY1 is defined as a direction that orthogonally intersects the rod axis AX1.

In the example of FIG. 1, the fact that the axis AX1 of the threaded rod 31 does not coincide with the axis of rotation AX of the arm 16 results in a rotation of the nut 32 being impossible. This aspect necessarily results in longitudinal movement of the nut 32 along the threaded rod 31 upon rotation of the threaded rod 31. Nevertheless, the steering column assembly 10 according to the invention is not limited to this specific arrangement of the threaded rod 31. A different arrangement of the threaded rod 31 is allowed if the following two conditions are met:
the nut 32 is translationally fixedly connected to the arm 16, and
the threaded rod 31 supporting the nut 32 is fixedly connected to the steering column body 14 in the longitudinal direction.

By way of a non-limiting example, it may be provided that the nut 32 may be secured against rotation along the threaded rod 31 by a specially designed blocking element.

Considering the steering column assembly 10 disposed in the vehicle, the electric motor 26 is activated during a step of adjusting the longitudinal position of the steering wheel to rotate the threaded rod 31. In response, the nut 32 moves along the threaded rod 31 and carries with it the arm 16 to which it is attached in its longitudinal motion. Depending on the thread direction of the threaded rod 31 and consequently the thread direction of the nut, rotation of the threaded rod by the electric motor 26 causes a displacement of the arm 16:
either in a so-called extension direction labeled S1, which brings the steering wheel closer to a driver's seat of the vehicle;
or in a so-called entry direction, labeled S2, which moves the steering wheel away from the driver's seat.

In the context of the invention, the motion transducer 30 is of a reversible nature to allow for a higher speed of movement of the nut 32 along the threaded rod with ISO output of the electric motor 26 and thus a higher speed of adjustment of the longitudinal position of the steering wheel. This reversible attribute of the motion transducer 30 corresponds to the ability to rotate the threaded rod 31, in order to carry the nut 32 translationally as well as, conversely, the movement of the nut 32 in the longitudinal direction in order to cause rotation of the threaded rod 31 in response thereto.

Nevertheless, unintended translational movement of the nut 32, i.e., outside of the adjustment phase, is undesirable. Thus, a fixed position of the steering wheel must be ensured when the electric motor 26 is in the idle state, i.e., the setting is not activated. A force exerted by the driver on the steering wheel in a driving situation must not cause the steering wheel to be moved via the electromechanical actuator 24.

The idea underlying the invention is thus based on the intention of securing the threaded rod 31 against rotation outside of an adjustment phase by the motor 26, thereby preventing longitudinal movement of the nut 32. If the nut 32 is blocked during the non-adjustment phase, the position of the arm 16 will be blocked, and consequently the position of the steering wheel, the position of which is determined by the position of the arm 16.

In this regard, the significant special feature of the invention is that the drive mechanism 28 comprises a mechanical coupling device 38 for allowing rotation of the threaded rod by the electric motor while at the same time securing the rod against rotation by the nut.

As can be seen in detail in FIG. 2, drive mechanism 28 is in the form of an angular gear that is integral with a housing 40 attached to steering column body 14. For this purpose, the housing 40 comprises mounting holes that are marked with 41. The electric motor 26 is also attached to the housing 40, thereby ensuring assembly of the electric motor 26 to the steering column body 14. The connection of the electric motor 26 and the drive mechanism 28 forms a so-called gear motor unit.

The drive mechanism 28 comprises a drive shaft 42 coupled to a motor output shaft, which is not shown. The drive shaft 42 is in the form of a screw and extends in a direction orthogonal to the longitudinal direction. A rotation of the drive shaft by the motor is transferred to the threaded rod 31 via the mechanical coupling device 38, which forms an interface between the two elements.

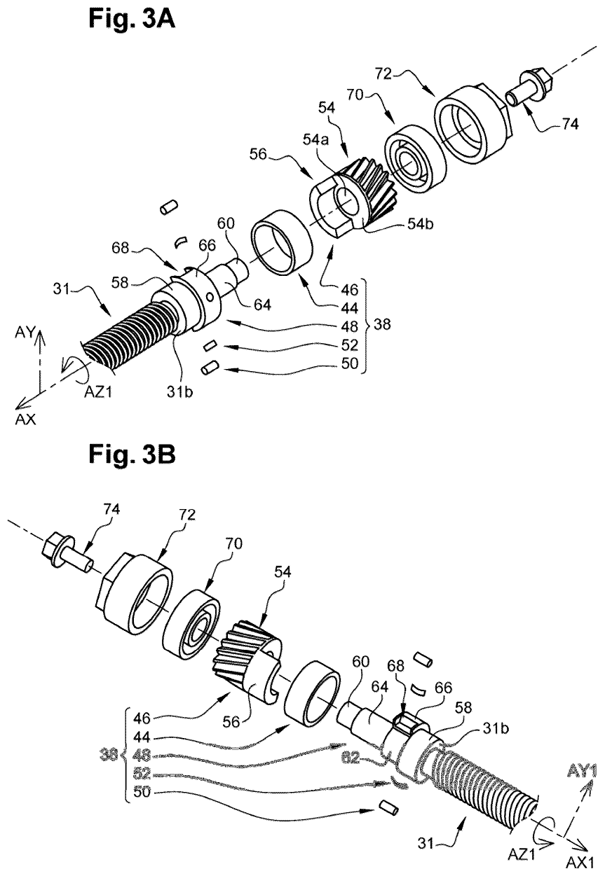

Referring to FIGS. 2, 3A, and 3B, the mechanical coupling device 38 is formed from the combination of a ring 44, a first transfer body 46, a second transfer body 48, a pair of rolling bodies 50, and a pair of elastic elements 52.

In the following, these elements will be described with reference to the threaded rod 31 and the drive shaft 42 as their dimensions and orientations relative to their destination are defined based on the interface between the threaded rod 31 and the drive shaft 42.

The first body 46 is in the form of an assembly formed from the rigid connection between a pinion 54 and a tab 56 that are either joined or formed as a single piece. The pinion 54 is disposed concentrically with the threaded rod 31 along AX1. It has an external teeth configured to engage with the drive shaft 42. In the example of the illustrations, the drive shaft 42 and the pinion 54 are left-facing helical gearing wheels that generate a reduction ratio. The pinion 54 has a through-opening at its center that bounds a cylindrical inner wall 54a having a longitudinal axis. In addition, it is bounded longitudinally by two side walls 54b that are perpendicular to the longitudinal direction. The side walls 54b may each correspond to a disc or surface forming the negative of the toothing contour of the pinion 54. The sidewalls 54b are radially bounded by the outer radial contour of the pinion 54 that corresponds to the teeth, and by the inner contour defined by the cylindrical inner wall. The tab 56 is in the form of a cylindrical section. It projects longitudinally beyond the side wall 54b of the pinion 54 facing the threaded rod 31. More specifically, the tab 56 extends across an arcuate section in a direction AZ1 corresponding to a yaw direction about the axis AX1.

It should be noted that the electromechanical actuator 24 is not limited to the orientation of the electric motor 26, and accordingly also not to the orientation of the drive shaft 42, as well as the shape of the threads of the drive shaft 42 and the pinion 54. In this example, the thread of the pinion 54 allows for the formation of a required angle gearing, wherein it is assumed that the drive shaft 42 extends orthogonally to the longitudinal direction of the threaded rod 31. However, a different orientation of the electric motor 26 and thus the drive shaft 42 may be provided by changing the thread of the pinion 54 without leaving the frame of the invention.

The second body 48 is in the form of a stepped shaft having a hollow body. It extends longitudinally concentrically with the threaded rod 31 along AX1. It is composed of a cascade of concentric rings, each extending in the longitudinal extent of another ring. In detail, the second body 48 is bounded longitudinally by a gripping ring 58 and a cover ring 60. Considering the longitudinal direction defined by the threaded rod 31 to the drive shaft 42, the second body 48 can be seen to include: a coupling ring 62 extending the gripping ring 58, a guide ring 64 extending the guide ring 64, and the cover ring 60 extending the guide ring 64.

From a functional point of view, the gripping ring 58 is formed to receive the second end 31b of the threaded rod 31, advantageously by press fitting to ensure a rotational coupling of the second body 48 to the threaded rod 31. This special feature leads to a translational blocking of the threaded rod 31 on the gear. The gripping ring 58 also functions as a longitudinal stop against which the tab 56 abuts.

The guide ring 64 engages with the opening of the pinion 54 in a slip fit to ensure the concentricity of the first and second bodies.

The coupling ring 62 has a radial projection 66. The radial projection 66 extends across a portion of the circumference of the coupling ring 62. Two radial recesses 68 are formed in the projection 66, with one of the two rolling bodies 50 and one of the two elastic members 52 arranged in each of them. The recesses extended in the circumferential direction, each at a circumferential end of the radial projection 66. In the example of FIGS. 3A and 3B, the recesses 68 are longitudinally bounded by two projecting residual walls 66. The projecting residual walls 66 ensure that the rolling bodies 50 are held in the longitudinal direction.

However, the invention is not limited to this specific shape of a projection 66 and also allows for the rolling elements and spring elements to be held between the first and second bodies that extend opposite one another.

The rolling bodies 50 are in the form of longitudinally oriented rollers, and the elastic elements are in the form of springs individually formed from a metallic strip.

The coupling ring 62 is longitudinally aligned with a portion C of a so-called overlapping of the mechanical coupling device 38 with the tab 56 of the first body 46.

In the example of the figures, the ring 44 has a cylindrical outer and inner surface. It is aligned so that the axis of rotation of its inner surface coincides with the axis AX1 of the threaded rod 31. It is press-fit into a corresponding recess formed in the housing 40 on its outer surface to block its rotation along AX1, while its inner surface surrounds the first and second bodies in slip fit at the overlap section C.

It should be noted that the outer surface of the ring 44 is not limited to having a circular contour. The outer surface may in particular be prismatic, i.e. have a polygonal contour. In this case, it should be understood that a rotation of the ring 44 is not possible when it is press-fit into the recess of the housing 40 that is shaped to have a contour that forms the negative of the contour of the outer surface.

Alternatively, the ring 44 may also be a component of the housing 40, i.e., formed directly by the housing 40. In this case, it should be understood that the housing 40 simply forms an annular inner surface that functions as the inner surface of the ring 44.

The drive mechanism 28 further includes:
a ball bearing 70 having an outer ring that is fixedly supported by the housing 40 and an inner ring that surrounds the cover ring 60. As can be understood, this arrangement forms a bearing for rotational guidance of the threaded rod 31 via the second body 48;
a conditioning ring 72 that is fitted into the housing 40 and through which a screw element 74 that is clamped into the cover ring 60 extends to help hold the threaded rod 31 axially with respect to the steering column body 14.

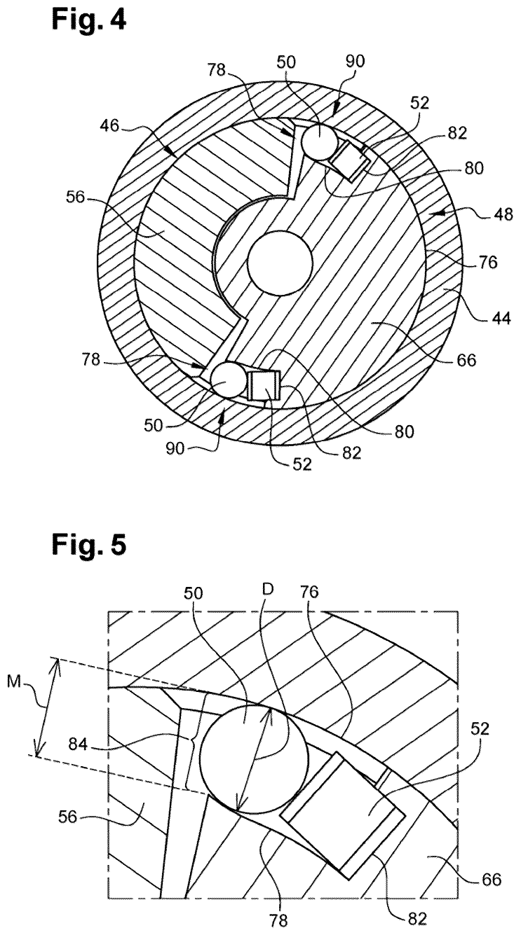

The arrangement of the elements extending at the overlap section C is described based on the appended FIGS. 4 and 5.

The inner wall of the ring 44, marked 76, surrounds the projection 66 and the tab 56. It extends radially around the recesses 68 to bound joint grooves 78.

Each groove 78 is bounded as follows:
radially through both a web 80 corresponding to the radial contour of the projection 66 taken from the associated recess 68 and through the inner surface of the ring 44 such that a radial hold of the corresponding rolling element 50 is ensured;
circumferentially through a groove base wall 82 corresponding to the circumferential end of the projection taken from the associated recess 68 and through a groove opening 84 corresponding to the circumferential end of this recess.

As can be understood, the recesses 68 correspond to volumes that are recessed in the projection 66 and bound its circumferential extension.

A significant feature is the orientation of the grooves. The grooves 78 have opposite orientations, i.e., the circumferential direction defined by the base wall 82 towards the groove opening 84 of the one groove corresponds to the opposite direction of the other.

Each web 80 of the second body 48 is shaped such that the radial extension of the corresponding groove 78 decreases in the circumferential direction with increasing proximity to the groove opening 84. This radial cross-sectional decrease is designed such that the radial extension of the groove 78 measured at the groove opening 84 marked M in FIG. 5 is smaller than the radial dimension of the rolling element 50 marked D. It follows that the rolling element 50 cannot be disengaged from the groove 78 by the groove opening 84.

Thus, the associated rolling element 50 is held in the circumferential direction in each groove 78 by both the groove base wall 82 and the groove opening 84.

The rolling bodies 50 are in the form of rollers that are oriented so that their axis extends in the longitudinal direction.

As for the elastic elements 52, they are each in the form of a metal strip and are each disposed pre-tensioned between the groove base wall 82 and the roller 50 of a single groove 78. They are configured to passively push the roller 50 away from the groove base wall 82 under elastic pre-tension, to press it towards the groove opening 84. As the roller 50 cannot be disengaged from the groove 78 by the groove opening 84, the roller 50 is consequently held between the web 80 and the inner ring surface 76 in a clamped position.

In practice, the pre-tension is ensured by the metal strips being sized such that their installation between the two protruding residual walls forces their deformation.

As the roller 50 cannot be disengaged from the groove 78 by the groove opening 84, the roller 50 is consequently held between the web 80 and the inner ring surface 76 in a clamped position.

In practice, any assembly formed from a groove 78 and the pair formed from a roller 50 and a spring 52 disposed within that groove represents a so-called blocking unit 90.

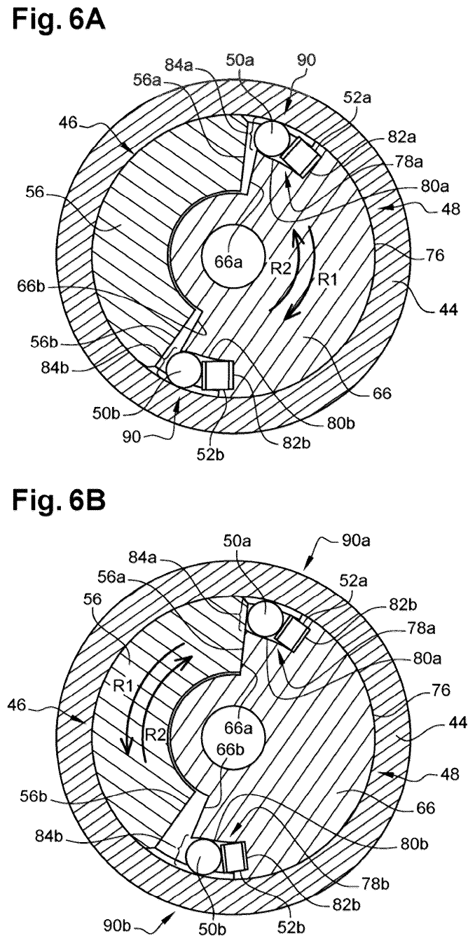

The following explains the dynamics of rotation and/or the blocking of the rotation of the threaded rod 31 based on FIGS. 6A and 6B, in which the components of the same blocking group are marked with either the letter a or the letter b for a better understanding.

Referring to FIG. 6A, during a non-adjustment phase, i.e., when the electric motor 26 is in the idle state, a longitudinal pulse on the nut 32 will tend to rotate the threaded rod 31. This rotation may correspond to either a screwing in or an unscrewing of the rod 31 depending on the direction of the longitudinal force applied to the nut 32.

Let us assume that the threaded rod 31 tends to be rotated about its rod axis AX1 in any direction marked R1. Since the second body 48 is rotationally fixedly connected to the threaded rod 31, it should be understood that the second body 48 also tends to rotate in the direction R1.

In the example of FIG. 6A, this direction R1 is opposite to the direction of pre-tension of the spring 52a exercised on a roller 50a of a first blocking group 90a. As the spring 52a presses the roller 50a in the direction opposite to direction R1 to keep it blocked between the inner ring wall 76 and the web 80a, which bounds groove 78a of the first group, the second body 48 is consequently secured against rotation in the direction R1.

This is because, in order to allow the second body 48 to rotate, the roller 50a must be able to rotate about itself by rolling on the inner ring wall 76. However, this rotation is prevented by a clamping action applied to the roller, which in turn is clamped by the web 80a and the inner ring wall 76 due to the combined effect of the decreased radial extension of the groove 78a and the elastic pre-tension of the spring 52a.

As the second body 48 is secured against rotation in the direction R1, the threaded rod is consequently secured against rotation in the same direction R1.

If we likewise assume that the threaded rod 31 tends to be rotated by a longitudinal force exerted on the nut 32 in a direction R2 that is opposite to the direction R1 about its rod axis AX1, then it is the second blocking group 90b which ensures rotational locking.

Similarly, the clamping action exerted on the roller 50b of the second group 90b due to the combined effect of the decreased radial extension of the groove 78b and the elastic pre-tension of the spring 52b prevents this roller 50b from rotating. In this case, this clamping effect results from the elastic pre-tensioning that presses the roller 50b in the direction opposite to the direction R2 in order to keep it blocked between the inner ring wall 76 and the web 80b, which bounds the groove 78b of the second group.

Referring to FIG. 6B, during an adjustment phase, that is, when the electric motor 26 is activated to rotate the drive shaft 42, the first body 46 is rotationally driven due to engagement of its pinion 54 with the drive shaft 42.

Let us first consider a rotation of the first body 46 in the direction S1. A rotation in the direction S1 causes the tab 56 to rotate towards the groove 78a of the first blocking group 90a.

In detail, a first circumferential end surface 56a of the tab 56 is abutted against a first circumferential end wall of the projection 66 marked 66a that extends radially to the groove opening 84a, as shown in FIG. 6B. The first circumferential end surface 56a of the tab 56 also extends radially along the groove opening 84a such that the abutment of the first circumferential end surface 56a against the first circumferential end wall 66a of the projection results in the roller 50a pressing towards the groove base 82a of the groove 78a.

When the torque provided by the electric motor 26 is sufficient, the pressure exerted by the first circumferential end surface 56a of the tab 56 on the roller 50a may overcome the pre-tension of the spring 52a. In this case, the roller 50a is disengaged from its clamping position because it moves towards the groove base 82a, opposite the pre-tensioning of the spring 52a.

Once the first circumferential end surface 56a of the tab 56 abuts the first circumferential end wall 66a of the projection 66, the first body carries the second body along in its rotation. Accordingly, a rotational coupling of the first and the second bodies will act in the direction R1 as the first blocking unit 90a will not counteract this rotation as a result of the roller 50a being disengaged. The threaded rod 31, being rotationally fixedly connected to the second body 48, is then rotated in the direction R1.

It should also be noted that the second blocking unit 90b does not ensure rotational locking of the second body 48 in this first direction of rotation R1. Thus, the roller 50b of the second blocking unit is naturally driven towards the groove floor 82b by the rotation of the second body 48 by the first body 46, and can thus roll on the inner wall 76 of the ring 44. This aspect arises from the fact that:
if the torque applied to the first body 46 is sufficient to overcome the pre-tension applied to the roller 50a by the spring 52a of the first blocking group 90a; then
the torque applied to the second body is also sufficient to cause the roller 50b to move toward the groove base 82b against the pre-tensioning of the spring 52b of the second blocking group 90b.

Similarly, assuming that the first body 46 is driven rotationally in the direction R2 opposite the direction R1, a rotation of the threaded rod 31 in the direction R2 is enabled.

A second circumferential end surface 56b of the tab 56 is abutted against a second circumferential end surface 66b of the projection 66 extending radially to the groove opening 84b.

Like the first circumferential end surface 56b, the second circumferential end surface 56b also extends radially along the groove opening 84b such that abutment of the second circumferential end surface 56b against the second circumferential end surface 66b of the projection 66 presses the roller 50b towards the groove base 82b of the groove 78b.

When the torque provided by the electric motor 26 is sufficient, the pressure exerted by the second circumferential end surface 56b of the tab 56 on the roller 50b may overcome the pre-tensioning of the spring 52b. The roller 50b is disengaged from its clamping position by moving towards the groove base 82b, opposite the pre-tensioning of the spring 52b.

Once the first circumferential end surface 56b of the tab 56 abuts the second circumferential end surface 66b of the projection 66, the first body 46 carries the second body 48 along on its rotation. A rotational coupling of the first and second bodies in the direction R2 will be effective since the first blocking unit 90a does not counteract this rotation as a result of the disengagement of the roller 50b. The threaded rod 31, being rotationally fixedly connected to the second body 48, is then rotated in the direction R2.

Due to the mirroring effect during a rotation of the first body 46 in the direction of rotation R1, the first blocking unit 90a does not provide for rotational locking of the second body 48 in this second direction of rotation R2. Thus, the roller 50a of the first blocking unit 90a is naturally driven towards the groove base 82a by rotation of the second body 48 by the first body 46, and can thus roll on the inner wall 76 of the ring 44.

In the foregoing description, which is based on the figures, the tab 56 is shaped such that the circumferential end surfaces 56a and 56b each:
form a release section extending in the circumferential direction opposite a groove opening to be suitable for abutting against the roller and for pressing it towards the corresponding groove base; and
form a contact section that extends in the circumferential direction opposite one of the walls of the second body to be suitable to abut this wall and to carry it with it in its rotational movement.

However, it should be noted that the invention is not limited to this special feature. In practice, the tab 56 can radially extend to have only circumferential end surfaces 56a, 56b that are aligned in the circumferential direction with the openings of the grooves 78a, 78b of the first and second blocking groups 90a, 90b, respectively.

In this arrangement, the dynamics of the rotational coupling of the first and the second bodies 46, 48, as described above in the adjustment phase, remain applicable. The only difference is that the rotation of the second body 48 by the first body 46 implies that the circumferential end surfaces 56a, 56b of the tab press the roller 50a, 50b towards the groove base 82a, 82b until the spring 52a, 52b is sufficiently deformed to transfer the torque from the first body 46 to the second body 48.

In practice, once the roller 50a, 50b sufficiently presses the spring 52a, 52b against the groove base wall 82a, 82b, they together form a material continuity between the considered peripheral end surface 56a, 56b and the opposite groove base wall 82a, 82b. It should be noted that, in this case, the springs are shaped so that the deformation they experience remains in the elastic area to maintain their ability to push the roller towards the groove opening to clamp it.

In the examples of FIGS. 6A and 6B, arbitrary directions of rotation are used to define the dynamic interaction of the components of the mechanical coupling device 38. It should be understood that, depending on the orientation of the threads of the threaded rod 31 and the nut 32:
the first direction of rotation R1 may correspond to a rotation of the rod inducing a movement of the nut in the direction S1 or S2 of FIG. 1; and consequently
the second direction of rotation R2 opposite the direction R1 may correspond to a rotation of the rod inducing movement of the nut in the direction S2 or S1 of FIG. 1.

Regardless of the direction of displacement S1 or S2 that corresponds to the direction of rotation R1 or R2 of the threaded rod 31, the mirror-image combination of the blocking units 90a, 90b of the mechanical coupling device 38, as described, allows for a lock against displacement of the nut 32 in one direction or the other by means of a rotational locking of the threaded rod 31.

It follows that the mechanical coupling device 38 enables the steering wheel supported by steering shaft 18 to be secured in position in a driving situation in which electric motor 26 is deactivated.

Based on this, it should be noted that the coupling device 38 is not limited to the form described, and in particular, is not limited to the presence of the two blocking units 90a, 90b. Thus, it may be desirable to secure the steering wheel, i.e., the nut, the position of which defines the steering wheel, against displacement only in a direction S1 or S2 of a longitudinal pulse applied to the steering wheel or nut 32.

In this regard, a single blocking unit 90 may be provided within the scope of the invention as defined, which secures the threaded rod 31 against rotation in a single direction of rotation, R1 or R2. Preferably, the selected direction of rotation R1 or R2 of the threaded rod for which the coupling device 38 ensures rotational locking in a non-adjustment situation of the steering wheel corresponds to the translation direction S1. In fact, it is more likely that a vehicle driver will push against the steering wheel in front of them in a driving situation, especially in an accident where the energy propels the driver forward.

In the example of the figures, rollers 50 are used as rolling bodies of the blocking units 90, wherein the invention is not limited to this special feature. The rollers may in particular be replaced by balls or barrel bearings.

The invention is also not limited to the use of metallic band springs. In practice, elastic elements of any type may be selected as long as they exert a compressive force on the rolling element to clamp it between the web 80 of the second body and the inner wall 76 of the ring 44.

The coupling device 38 has been described to refer to a gear element disposed within a gearbox 40 and providing an interface for reducing a speed. In particular, the first body 46 has been described as comprising a pinion 54 that interlocks with a drive shaft 42 driven directly by the electric motor 26 to produce a reduction ratio.

It should be noted that the coupling device 38 is not limited to this specific arrangement. In practice, the coupling device 38 may be disposed at any determination position along drive mechanism 28 as long as it satisfies its function of blocking/rotating threaded rod 31. Stated differently, according to the invention, it is not required that the coupling device be an integral part of a gearing module and that, in particular, the first body has a pinion gear 54 that is intended to engage with the drive shaft 42.

The coupling device 38 has been described as countering an undesirable effect associated with the use of a screw-nut type reversible transducer within an electromechanical actuator 24 for adjusting the position of a steering wheel in a steering column assembly. It allows the rotation of a threaded rod 31 to be distinguished in that it allows rotation when it is desired and prevents rotation when it is unintentional. However, it should be noted that the invention is not limited to this specific use.

On the one hand, the second body 48 has been described as being coupled to the threaded rod 31. It should be noted that this special feature arises directly from the arrangement of the motion transducer 30 and is not limiting in itself. Thus, in the context of the invention, it is possible to reverse the operation of the transducer, wherein the threaded rod 31 is translationally fixedly connected to the arm 16 and complementarily the nut 32 is translationally fixedly connected to the steering column body 14 and is rotationally driven by the electric motor 26 via the drive mechanism 28 to achieve a similar function. In this case, the coupling device 38 is to be installed inversely.

On the other hand, and more generally formulated, the use of the coupling device 38 according to the invention is not limited to an application for an electromechanical actuator 24 having a reversible screw-nut transducer. The coupling device 38 may be an attachment in any mechanism where selectively blocking or allowing a rotation of one shaft by another in one direction by a single blocking unit or in two directions by two blocking units is desired. A shaft corresponds to a mechanical body that transmits a force in the form of torque and rotational movement, and may refer to any element rotatable about an axis of rotation, such as a pinion or gear, regardless of its thickness. The following listing of claims replaces all prior versions, and listings, of claims in the application:

1. A mechanical coupling device for selective rotational coupling of a first shaft to a second shaft to permit rotation of the second shaft by the first shaft while blocking rotation of the first shaft by the second shaft, the mechanical coupling device comprising:
a first rotating body which is designed to be rotationally fixedly connected to the first shaft or form a constitutive element thereof;
a second rotating body which is designed to be rotationally fixedly connected to the second shaft or form a constitutive element thereof, wherein the second body extends concentrically with the first body along a longitudinal axis
a rotationally fixed ring surrounding the first body and the second body radially to the longitudinal axis along an overlap section where the first and second bodies overlap longitudinally; and
a first blocking unit for rotation of the first shaft by the second shaft in a first direction of rotation wherein the first blocking unit comprises a first groove as well as a first elastic element and a first rolling element encapsulated in the first groove (78a),
wherein the first groove extends in a circumferential direction defined as a yaw direction about the longitudinal axis bounded between a groove base wall formed by the second body and a groove opening wherein the first direction of rotation is defined as the direction from the groove opening to the groove base
wherein the first groove is formed radially by a web formed by the second body and bounded by a cylindrical inner wall of the ring opposite the surface of the web wherein the web is shaped such that the radial extension of the groove is reduced in the circumferential direction with increasing proximity to the groove opening so that the rolling body cannot disengage from the groove due to the groove opening;
wherein the first elastic element is disposed between the groove base wall and the first rolling element wherein the first elastic element passively pushes the first rolling element away from the groove base wall to press it towards the groove opening until the first rolling element is held in the clamped position the between the web and the inner ring wall; and
wherein the first body comprises a release section configured to permit rotation of the second shaft by the first shaft in the first direction of rotation wherein the release section extends in the circumferential direction opposite the groove opening to be suitable to come into contact with the first rolling element and to press it towards the groove base when the first body is rotated in the first direction of rotation opposite the pre-tensioning direction of the first elastic element and at the same time the torque is sufficient to overcome the pre-tensioning of the first elastic element and to disengage the first rolling element from the clamped position.

2. The mechanical coupling device according to claim 1, further comprising a second blocking unit for rotating the first shaft by the second shaft in a second direction of rotation opposite the first direction of rotation wherein the second blocking unit comprises a second groove which is defined between the ring and the first and second bodies as well as a second elastic element and a second rolling element encapsulated in the second groove,
wherein the second groove extends in the circumferential direction bounded by a respective groove base wall formed by the second body and a respective groove opening wherein the second groove is aligned such that the direction from the opening of the second groove to the base wall corresponds to the second groove of the second direction of rotation;
wherein the second groove is radially bounded by a web formed by the second body and bounded by the cylindrical ring inner wall opposite to this web wherein the web is formed such that the radial extension of the second groove is reduced in the circumferential direction with increasing proximity to the opening of the second groove, such that the second rolling element cannot become disengaged from the second groove by the groove opening;
wherein the second elastic element is disposed between the base wall of the second groove and the second rolling element wherein the second elastic element passively pushes the second rolling element away from the base wall of the second groove to press it towards the opening of the second groove, until the second rolling element is held in a clamped position between the web and the inner ring wall; and
wherein the first body comprises a second release section configured to permit rotation of the second shaft by the first shaft in the second direction of rotation wherein the second release section extends in the circumferential direction opposite the opening of the second groove, to be able to come into contact with the second rolling element and to press it towards the base wall of the second groove when the first body is rotated in the second direction of rotation opposite the pre-tensioning direction of the second elastic element and at the same time the torque is sufficient to overcome the pre-tensioning of the second elastic element and to disengage the second rolling element from the clamped position.

3. The mechanical coupling device according to claim 1, wherein the rotation of the second shaft by the first shaft in the direction of rotation which is blocked by the corresponding blocking unit through a support surface of the first body which comes into contact with a support surface of the second body is ensured when the rolling element is released from the clamped position by the release section, and wherein the first and the second support surface may at least partially overlay each other in the circumferential direction.

4. The mechanical coupling device according to claim 1, wherein the rotation of the second shaft by the first shaft in the direction of rotation blocked by the corresponding blocking unit is ensured by the rolling element and the corresponding elastic element forming a contact interface between the release section of the first body and the groove base wall of the blocking unit.

5. A steering column assembly for a steering system of a vehicle, comprising:
a steering column body fixedly mounted to a vehicle structure;
an arm supported by the steering column body extending in a longitudinal direction wherein the arm is at least partially fitted into the steering column body and is translationally displaceable in the longitudinal direction with respect to the steering column body; and
an electromechanical actuator for translational movement of the arm in the longitudinal direction, wherein the electromechanical actuator comprises:
an electric motor for rotary drive;
a screw-nut-type motion transducer configured to convert a rotation provided by the electric motor into a displacement of the arm wherein the motion transducer comprises a threaded rod translationally fixed relative to the steering column body and a nut rotationally fixed and translationally fixedly connected to the arm in the longitudinal direction; and
a mechanical rotational coupling device according to claim 1 for rotationally coupling the threaded rod to a drive shaft driven rotationally at the output of the electric motor.

6. The steering column assembly according to claim 5, wherein the mechanical rotational coupling device is an integral part of a drive mechanism which is enclosed in a housing fastened to the steering column body and via which a rotation provided by the electric motor is transferred to the threaded rod wherein the drive mechanism comprises the drive shaft driven by the electric motor wherein the first body comprises a pinion which extends beyond the overlap section and wherein the pinion comprises a toothing which engages with a toothing of the drive shaft.

7. The steering column assembly according to claim 6, wherein the ring is formed by the housing.

8. The steering column assembly according to claim 6, wherein the ring is attached to the housing.

9. The steering column assembly according to claim 5, wherein the rolling element(s) are rollers.

10. The steering column assembly according to claim 5, wherein the elastic element(s) are formed from a metallic strip.

11. The steering column assembly according to claim 5, wherein the vehicle is a motor vehicle.
